(19) United States
(12) Patent Application Publication
(10) Pub. No.: US 2026/0338278 A1
(43) Pub. Date: Oct. 29, 2026

(54) ROTARY JOINT

(71) Applicant: PILLAR CORPORATION, Osaka (JP)

(72) Inventors: Takayuki Iwasa, Osaka (JP); Muneyuki Chonan, Osaka (JP); Takato Fukumoto, Chuzhou City (CN)

(73) Assignee: PILLAR CORPORATION, Osaka (JP)

(21) Appl. No.: 19/657,981

(22) Filed: Apr. 24, 2026

(30) Foreign Application Priority Data
Apr. 28, 2025 (JP) 2025-074017

(51) Int. Cl. F16J 15/40; F16J 15/34

(52) U.S. Cl. CPC F16J 15/406; F16J 15/342

(57) ABSTRACT

A rotary joint includes: a mechanical seal having a first rotary sealing ring, a first stationary sealing ring, a second stationary sealing ring, and a second rotary sealing ring; a first back pressure chamber for applying a fluid pressure of a first fluid to the second stationary sealing ring; and a second back pressure chamber for applying a fluid pressure of a second fluid to the second stationary sealing ring. An outer shape of the second stationary sealing ring is formed such that a first balance ratio when subjected to the fluid pressure of the first fluid within the first back pressure chamber and a second balance ratio when subjected to the fluid pressure of the second fluid within the second back pressure chamber are equivalent.

### TECHNICAL FIELD

The present disclosure relates to a rotary joint. This application claims priority on Japanese Patent Application No. 2025-074017 filed on Apr. 28, 2025, the entire content of which is incorporated herein by reference.

### BACKGROUND ART

A rotary joint including a stationary non-contact mechanical seal is known as a rotary joint for connecting a flow passage in a fixed-side member and a flow passage in a rotary-side member (see, for example, PATENT LITERATURE 1). FIG. 9 is a cross-sectional view showing a conventional rotary joint. This rotary joint includes a tubular case body 80, a rotary shaft 81 rotatably provided in the case body 80, and a mechanical seal 82 placed between the case body 80 and the rotary shaft 81.

In the case body 80, a first outer flow passage 80a and a second outer flow passage 80b are formed at an interval in the axial direction so as to penetrate in the radial direction. In the rotary shaft 81, a first inner flow passage 81a and a second inner flow passage 81b are formed so as to be open at an interval in the axial direction on the outer circumferential side. The mechanical seal 82 includes a pair of first stationary sealing rings 84 and 85 and a pair of second stationary sealing rings 86 and 87 provided in the case body 80, and a first rotary sealing ring 88 and a second rotary sealing ring 89 provided on the rotary shaft 81.

In the first rotary sealing ring 88, a first communication flow passage 88a for connecting the first outer flow passage 80a and the first inner flow passage 81a is formed. A first fluid 91 flows through a first flow passage 90a that includes the first outer flow passage 80a, the first communication flow passage 88a, and the first inner flow passage 81a.

In the second rotary sealing ring 89, a second communication flow passage 89b for connecting the second outer flow passage 80b and the second inner flow passage 81b is formed. A second fluid 92 flows through a second flow passage 90b that includes the second outer flow passage 80b, the second communication flow passage 89b, and the second inner flow passage 81b.

The pair of first stationary sealing rings 84 and 85 are placed on both sides in the axial direction of and adjacent to the first rotary sealing ring 88. The space between each first stationary sealing ring 84 or 85 and the first rotary sealing ring 88 is sealed in a non-contact state by the static pressure of a seal gas 93 supplied therebetween. The seal gas 93 passes through a first gas flow passage 94 that includes a first gas supply passage 94a formed in the case body 80 and first gas holes 94b formed in the respective first stationary sealing rings 84 and 85, and is supplied between each first stationary sealing ring 84 or 85 and the first rotary sealing ring 88.

A pair of second stationary sealing rings 86 and 87 are placed on both sides in the axial direction of and adjacent to the second rotary sealing ring 89. The space between each second stationary sealing ring 86 or 87 and the second rotary sealing ring 89 is sealed in a non-contact state by the static pressure of the seal gas 93 supplied therebetween. The seal gas 93 passes through a second gas flow passage 95 that includes a second gas supply passage 95a formed in the case body 80 and second gas holes 95b formed in the respective second stationary sealing rings 86 and 87, and is supplied between each second stationary sealing ring 86 or 87 and the second rotary sealing ring 89.

On the side of each first stationary sealing ring 84 or 85 opposite to the first rotary sealing ring 88, a first back pressure chamber 96a is formed. In each first stationary sealing ring 84 or 85, a first back pressure flow passage 97a that connects the first back pressure chamber 96a and the first flow passage 90a is formed. A part of the first fluid 91 flowing through the first flow passage 90a passes through the first back pressure flow passage 97a and flows into each first back pressure chamber 96a. Each first stationary sealing ring 84 or 85 is subjected to the fluid pressure (back pressure) of the first fluid 91 within the first back pressure chamber 96a. The pressure-receiving area of each first stationary sealing ring 84 or 85 that is subjected to this fluid pressure, is set such that the balance ratio of a sealing structure between each first stationary sealing ring 84 or 85 and the first rotary sealing ring 88 is appropriate.

On the opposite side of each second stationary sealing ring 86 or 87 opposite to the second rotary sealing ring 89, a second back pressure chamber 96b is formed. In each second stationary sealing ring 86 or 87, a second back pressure flow passage 97b that connects the second back pressure chamber 96b and the second flow passage 90b is formed. A part of the second fluid 92 flowing through the second flow passage 90b passes through the second back pressure flow passage 97b and flows into each second back pressure chamber 96b. Each second stationary sealing ring 86 or 87 is subjected to the fluid pressure (back pressure) of the second fluid 92 within the second back pressure chamber 96b. The pressure-receiving area of each second stationary sealing ring 86 or 87 that is subjected to this fluid pressure, is set such that the balance ratio of a sealing structure between each second stationary sealing ring 86 or 87 and the second rotary sealing ring 89 is appropriate.

### CITATION LIST

### Patent Literature

PATENT LITERATURE 1: Japanese Laid-Open Patent Publication No. 2023-183943

### SUMMARY OF THE INVENTION

### Technical Problem

In the above rotary joint, in order to provide a single communication flow passage 88a (89b), it is necessary to place two stationary sealing rings 84 and 85 (86 and 87) on both sides in the axial direction of the rotary sealing ring 88 (89) (on both the upper and lower sides in FIG. 9). Therefore, if the number of communication flow passages 88a (89b) increases, the overall length in the axial direction of the rotary joint will become longer. Therefore, in the above rotary joint, it is conceivable to eliminate either one of the two stationary sealing rings 85 and 86 located at the intermediate position in the axial direction. However, in that case, the following problems arise.

For example, if the second stationary sealing ring 86 is omitted, a part of the second fluid 92 flowing through the second flow passage 90b passes through the axially lower side of the second rotary sealing ring 89 and flows into the radially inner side of the first stationary sealing ring 85. For this reason, the first stationary sealing ring 85 is subjected to the fluid pressure of the second fluid 92 on the radially inner side with respect to an O-ring 98 that partitions the first back pressure chamber 96a on the axially upper side thereof. Therefore, when only the first fluid 91 flows, the first stationary sealing ring 85 is subjected to the fluid pressure of the first fluid 91 within the first back pressure chamber 96a as usual, but, when only the second fluid 92 flows, the first stationary sealing ring 85 is subjected to the fluid pressure of the second fluid 92.

However, as shown in FIG. 10 and FIG. 11, at the first stationary sealing ring 85, a pressure-receiving area A92 (FIG. 11) subjected to the fluid pressure of the second fluid 92 is smaller than a pressure-receiving area A91 (FIG. 10) subjected to the fluid pressure of the first fluid 91 within the first back pressure chamber 96a. For this reason, the balance ratio of the sealing structure between the first stationary sealing ring 85 and the first rotary sealing ring 88 when subjected to the fluid pressure of the second fluid 92 is smaller than that when subjected to the fluid pressure of the first fluid 91. When the balance ratio becomes smaller as described above, the force that tends to close the space between the first stationary sealing ring 85 and the first rotary sealing ring 88 in the sealing structure weakens, leading to a decrease in sealing performance.

The present disclosure has been made in view of such circumstances, and an object of the present disclosure is to provide a rotary joint that can inhibit an overall length in an axial direction thereof from becoming longer, while maintaining the sealing performance of a mechanical seal, even when the number of communication flow passages increases.

### Solution to Problem

(1) A rotary joint of the present disclosure is a rotary joint including: a tubular case body having a first outer flow passage and a second outer flow passage that are open at an interval in an axial direction on an inner circumferential side; a rotary shaft rotatably provided within the case body and having a first inner flow passage and a second inner flow passage that are open at an interval in the axial direction on an outer circumferential side; and a hydrostatic non-contact mechanical seal placed between the case body and the rotary shaft and having a first communication flow passage for connecting the first outer flow passage and the first inner flow passage and a second communication flow passage for connecting the second outer flow passage and the second inner flow passage, a first fluid flowing through a first flow passage including the first outer flow passage, the first communication flow passage, and the first inner flow passage, a second fluid flowing through a second flow passage including the second outer flow passage, the second communication flow passage, and the second inner flow passage. The mechanical seal includes: a first rotary sealing ring provided on the rotary shaft and having the first communication flow passage formed therein; a first stationary sealing ring provided on one axial side of and adjacent to the first rotary sealing ring in the case body, a space between the first stationary sealing ring and the first rotary sealing ring being sealed in a non-contact manner by a seal gas; a second stationary sealing ring provided on another axial side of and adjacent to the first rotary sealing ring in the case body, a space between the second stationary sealing ring and the first rotary sealing ring being sealed in a non-contact manner by the seal gas; a second rotary sealing ring provided on the other axial side with respect to the second stationary sealing ring at the rotary shaft, and having the second communication flow passage formed therein; and a third stationary sealing ring provided on the other axial side of and adjacent to the second rotary sealing ring in the case body, a space between the third stationary sealing ring and the second rotary sealing ring being sealed in a non-contact manner by the seal gas. The rotary joint includes: a first back pressure chamber, provided on the other axial side and a radially outer side of the second stationary sealing ring, for applying a fluid pressure of the first fluid to the second stationary sealing ring; a second back pressure chamber, provided on the other axial side and a radially inner side of the second stationary sealing ring, for applying a fluid pressure of the second fluid to the second stationary sealing ring; a first back pressure flow passage connecting the first back pressure chamber and the first flow passage; and a second back pressure flow passage connecting the second back pressure chamber and the second flow passage. An outer shape of the second stationary sealing ring is formed such that a first balance ratio when subjected to the fluid pressure of the first fluid within the first back pressure chamber and a second balance ratio when subjected to the fluid pressure of the second fluid within the second back pressure chamber are equivalent.

In the rotary joint of the present disclosure, when two communication flow passages (first communication flow passage and second communication flow passage) are arranged between the case body and the rotary shaft, the mechanical seal may include three stationary sealing rings (first stationary sealing ring, second stationary sealing ring, and third stationary sealing ring). In the conventional rotary joint (FIG. 9), four such stationary sealing rings are required in order to provide the two communication flow passages, so that the number of stationary sealing rings can be made smaller in the present disclosure. Therefore, according to the present disclosure, even when the number of communication flow passages increases, the overall length in the axial direction of the rotary joint can be inhibited from becoming longer than in the conventional art.

Furthermore, when only the first fluid flows, a part of the first fluid flowing through the first flow passage passes through the first back pressure flow passage and flows into the first back pressure chamber provided on the other axial side and the radially outer side of the second stationary sealing ring. Accordingly, the second stationary sealing ring is subjected to the fluid pressure of the first fluid within the first back pressure chamber. Furthermore, when only the second fluid flows, a part of the second fluid flowing through the second flow passage passes through the second back pressure flow passage and flows into the second back pressure chamber provided on the other axial side and the radially inner side of the second stationary sealing ring. Accordingly, the second stationary sealing ring is subjected to the fluid pressure of the second fluid within the second back pressure chamber. Therefore, the outer shape of the second stationary sealing ring is formed such that the first balance ratio when subjected to the fluid pressure of the first fluid and the second balance ratio when subjected to the fluid pressure of the second fluid are equivalent. Therefore, the force that tends to close the space between the second stationary sealing ring and the first rotary sealing ring also becomes equivalent, and thus it is possible to inhibit the overall length in the axial direction of the rotary joint from becoming longer than in the conventional art while maintaining the sealing performance of the mechanical seal.
(2) In the rotary joint of (1) above, preferably, the case body has an annular protrusion that protrudes radially inward on the one axial side of the second rotary sealing ring and to which the second stationary sealing ring is attached, the second back pressure flow passage has a radial gap between the protrusion and the rotary shaft, and an axial gap between the protrusion and the second rotary sealing ring, the radial gap communicates with the second back pressure chamber, and the axial gap communicates with the second flow passage.

In this case, the second back pressure flow passage has the radial gap between the protrusion, to which the second stationary sealing ring is attached, and the rotary shaft, and the axial gap between the protrusion and the second rotary sealing ring. Therefore, by using the protrusion to which the second stationary sealing ring is attached, the second back pressure flow passage can be easily formed.
(3) In the rotary joint of (2) above, preferably, the protrusion has an annular mounting groove that is formed therein so as to be open on the one axial side and into which the second stationary sealing ring is fitted, and the rotary joint further includes a sealing member provided between the mounting groove and the second stationary sealing ring and partitioning the first back pressure chamber and the second back pressure chamber.

In this case, the first back pressure chamber and the second back pressure chamber can be easily formed by the sealing member provided between the mounting groove of the protrusion and the second stationary sealing ring.

### Advantageous Effects of the Invention

Therefore, it is possible to inhibit an overall length in the axial direction of the rotary joint of the present disclosure from becoming longer, while maintaining the sealing performance of the mechanical seal, even when the number of communication flow passages increases.

### BRIEF DESCRIPTION OF DRAWINGS

FIG. 1 is a cross-sectional view showing a rotary joint according to an embodiment of the present disclosure.

FIG. 2 is an enlarged cross-sectional view showing the lower side of the rotary joint.

FIG. 3 is an enlarged cross-sectional view showing the upper side of the rotary joint.

FIG. 4 illustrates a balance ratio of a sealing structure between a first stationary sealing ring and a first rotary sealing ring.

FIG. 5 illustrates a first balance ratio of a sealing structure between a second stationary sealing ring and the first rotary sealing ring.

FIG. 6 illustrates a second balance ratio of the sealing structure between the second stationary sealing ring and the first rotary sealing ring.

FIG. 7 illustrates the balance ratio of a sealing structure between a third stationary sealing ring and a second rotary sealing ring.

FIG. 8 is a cross-sectional view showing modifications of the first stationary sealing ring, the second stationary sealing ring, and the third stationary sealing ring.

FIG. 9 is a cross-sectional view showing a conventional rotary joint.

FIG. 10 illustrates a case where, in the conventional rotary joint, a first stationary sealing ring is subjected to the fluid pressure of a second fluid.

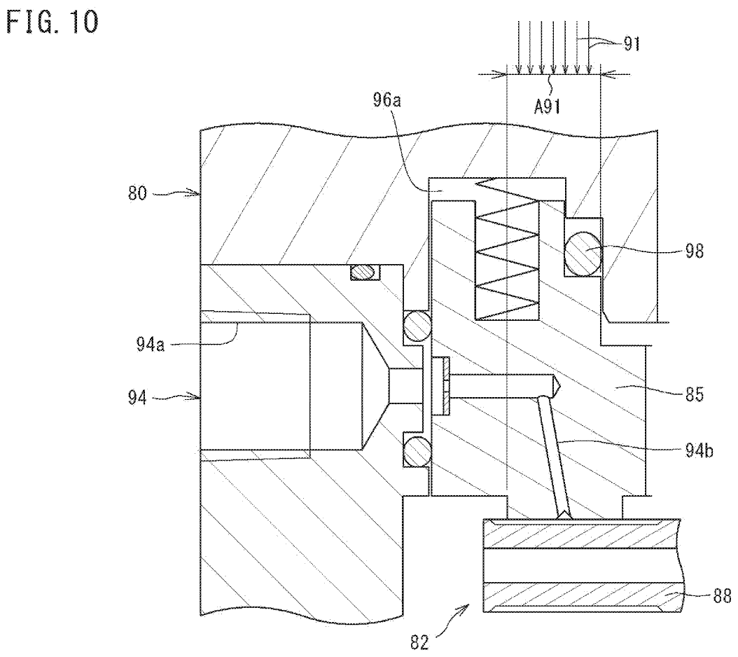

FIG. 11 illustrates a case where, in the conventional rotary joint, the first stationary sealing ring is subjected to the fluid pressure of a first fluid.

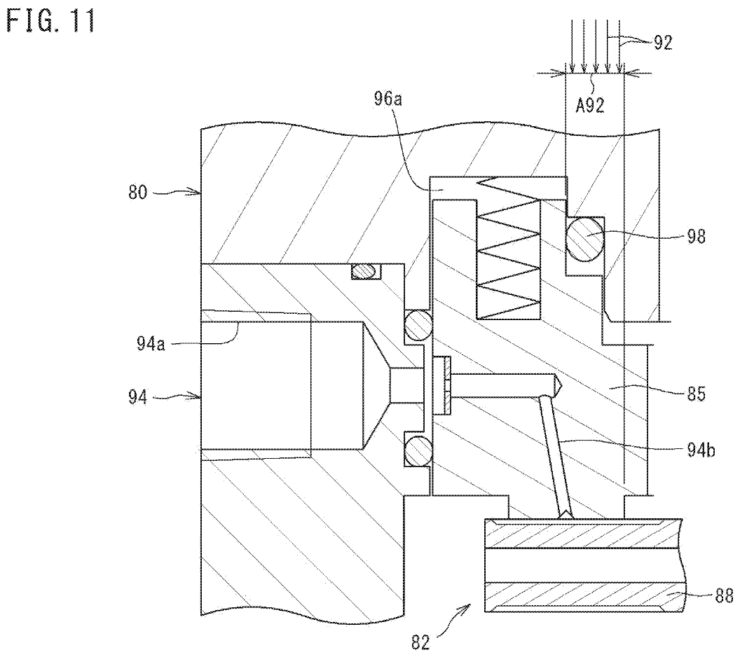

### DETAILED DESCRIPTION

Next, a preferred embodiment will be described with reference to the accompanying drawings.

### Entire Configuration

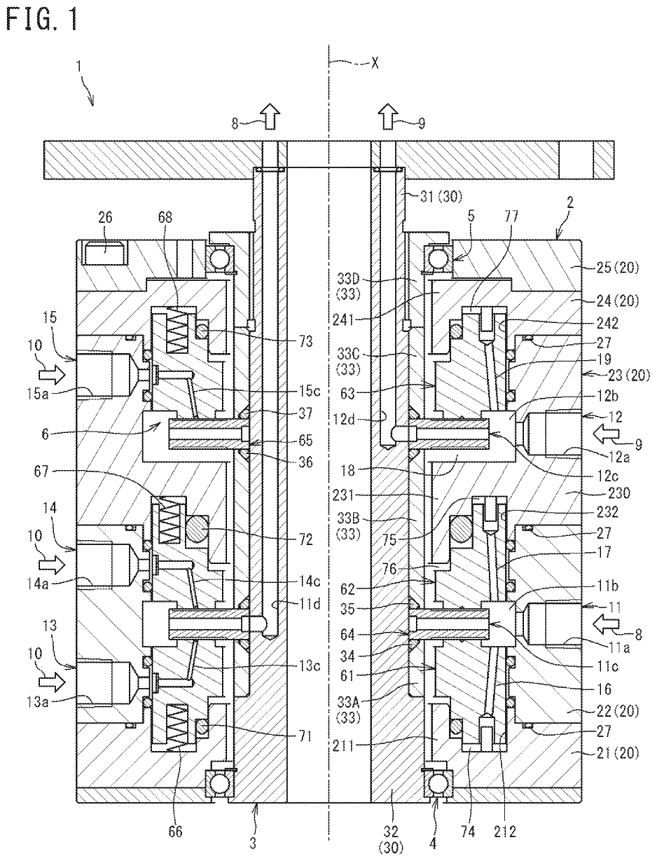

FIG. 1 is a cross-sectional view showing a rotary joint 1 according to an embodiment of the present disclosure. The rotary joint 1 is used in a rotary machine such as a single-wafer cleaning device for cleaning semiconductor wafers. The rotary joint 1 includes a tubular case body 2 and a tubular rotary shaft 3. The case body 2 is attached to a fixed-side member of the rotary machine (not shown). The rotary shaft 3 is attached to the rotary-side member of the rotary machine (not shown). The case body 2 and the rotary shaft 3 of the present embodiment are placed such that the axial direction is the up-down direction.

In the present disclosure, the “axial direction” is a direction along a center line X of the rotary joint 1 (including a direction parallel to the center line X). In addition, in the present disclosure, the “radial direction” is a direction orthogonal to the center line X of the rotary joint 1, and the “circumferential direction” is a direction around the center line X of the rotary joint 1. The orientation of the rotary joint 1 may be an orientation different from that shown in FIG. 1, but, in the present disclosure, for convenience of description, the axially lower side (one axial side) shown in FIG. 1 is referred to as “lower side” of the rotary joint 1, and the axially upper side (another axial side) shown in FIG. 1 is referred to as “upper side” of the rotary joint 1.

### Case Body

The case body 2 has a plurality of annular flanges 20 stacked in the axial direction. The plurality of flanges 20 are composed of a first flange 21, a second flange 22, a third flange 23, a fourth flange 24, and a fifth flange 25, stacked in this order from the lower side. All flanges 21 to 25 are fixed in a stacked state by a bolt 26. Accordingly, the case body 2 is formed in a tubular shape as a whole.

The space between the first flange 21 and the second flange 22, the space between the second flange 22 and the third flange 23, and the space between the third flange 23 and the fourth flange 24 are each sealed by an O-ring 27.

The first flange 21 has an annular protrusion 211 that protrudes radially inward relative to the second flange 22. The protrusion 211 is placed radially outward of a large-diameter portion 32 of the rotary shaft 3. In the protrusion 211, an annular mounting groove 212 that is open upward is formed.

The second flange 22 is formed to be longer in the axial direction than the first flange 21. In an axial center portion of the second flange 22, a first outer flow passage 11a is formed so as to penetrate in the radial direction. A first fluid 8 flows through the first outer flow passage 11a. The first fluid 8 is not particularly limited. The first fluid 8 of the present embodiment is, for example, pressurized air.

In a lower portion of the second flange 22, a first gas supply passage 13a is formed so as to penetrate in the radial direction. In an upper portion of the second flange 22, a second gas supply passage 14a is formed so as to penetrate in the radial direction. A seal gas 10 is supplied to the first gas supply passage 13a and the second gas supply passage 14a. The seal gas 10 is not particularly limited as long as it is a gas. The seal gas 10 of the present embodiment is pressurized air, which is the same type of fluid as the first fluid 8.

The third flange 23 has a flange body 230 and a protrusion 231. The flange body 230 has the same inner diameter as the second flange 22. In a center portion of the flange body 230, a second outer flow passage 12a is formed so as to penetrate in the radial direction. A second fluid 9 such as pressurized air flows through the second outer flow passage 12a. The second fluid 9 is not particularly limited. The second fluid 9 of the present embodiment is, for example, pressurized air, which is the same type of fluid as the first fluid 8. In an upper portion of the flange body 230, a third gas supply passage 15a is formed so as to penetrate in the radial direction. The seal gas 10 is supplied to the third gas supply passage 15a.

The protrusion 231 of the third flange 23 protrudes radially inward from a lower portion of the flange body 230 below a second rotary sealing ring 65, which will be described later. The protrusion 231 is formed in an annular shape. The upper end surface of the protrusion 231 is located with a gap in the axial direction with respect to the lower end surface of the second rotary sealing ring 65. The inner circumferential surface of the protrusion 231 is located with a gap in the radial direction with respect to the outer circumferential surface of a second sleeve 33B of the rotary shaft 3. In the protrusion 231, an annular mounting groove 232 that is open downward is formed.

The fourth flange 24 has an annular protrusion 241 that protrudes radially inward relative to the flange body 230 of the third flange 23. The protrusion 241 is placed radially outward of a third sleeve 33C and a fourth sleeve 33D of the rotary shaft 3. In the protrusion 241, an annular mounting groove 242 that is open downward is formed. The fifth flange 25 has a smaller inner diameter than the fourth flange 24.

Thus, in the case body 2, a first outer flow passage 11a and a second outer flow passage 12a that are open at an interval in the axial direction on the inner circumferential side are formed. The openings on the outer circumferential side of the case body 2 at the first outer flow passage 11a and the second outer flow passage 12a serve as inlet ports through which the first fluid 8 and the second fluid 9 flow in from the fixed-side member, respectively.

### Rotary Shaft

The rotary shaft 3 is rotatably provided within the case body 2. The rotary shaft 3 has a tubular shaft body 30 and a plurality of tubular sleeves 33 fitted on the outer circumference of the shaft body 30. The shaft body 30 has a small-diameter portion 31 that occupies a major part thereof in the axial direction, and the large-diameter portion 32 formed below the small-diameter portion 31. The outer diameter of the small-diameter portion 31 is smaller than the outer diameter of the large-diameter portion 32.

The small-diameter portion 31 has a first inner flow passage 11d and a second inner flow passage 12d that extend in the axial direction in a thickness portion in the radial direction thereof. The first inner flow passage 11d and the second inner flow passage 12d are formed at different positions in the circumferential direction from each other. One end of each of the first inner flow passage 11d and the second inner flow passage 12d is open at the upper end surface of the rotary shaft 3 and is connected to a flow passage of the rotary-side member (not shown).

The other end of the first inner flow passage 11d is open at a height position corresponding to the first outer flow passage 11a of the case body 2 on the outer circumferential surface of the small-diameter portion 31. The other end of the second inner flow passage 12d is open at a height position corresponding to the second outer flow passage 12a of the case body 2 on the outer circumferential surface of the small-diameter portion 31. Accordingly, in the rotary shaft 3, the first inner flow passage 11d and the second inner flow passage 12d, which are open at an interval in the axial direction on the outer circumferential side, are formed.

On the outer circumference of the small-diameter portion 31, a plurality of sleeves 33, and a first rotary sealing ring 64 and a second rotary sealing ring 65, which will be described later, are fitted. The outer diameter of each sleeve 33 is the same as the outer diameter of the large-diameter portion 32. The plurality of sleeves 33 include a first sleeve 33A, the second sleeve 33B, the third sleeve 33C, and the fourth sleeve 33D.

On the outer circumference of the small-diameter portion 31, in order from the lower side to the upper side, the first sleeve 33A, the first rotary sealing ring 64, the second sleeve 33B, the second rotary sealing ring 65, the third sleeve 33C, and the fourth sleeve 33D are fitted. The large-diameter portion 32 restricts the plurality of sleeves 33, the first rotary sealing ring 64, and the second rotary sealing ring 65 from coming off downward from the shaft body 30.

An O-ring 34 is provided on the upper surface of the first sleeve 33A to seal between the outer circumferential surface of the small-diameter portion 31 and the lower surface of the first rotary sealing ring 64. An O-ring 35 is provided on the lower surface of the second sleeve 33B to seal between the outer circumferential surface of the small-diameter portion 31 and the upper surface of the first rotary sealing ring 64.

An O-ring 36 is provided on the upper surface of the second sleeve 33B to seal between the outer circumferential surface of the small-diameter portion 31 and the lower surface of the second rotary sealing ring 65. An O-ring 37 is provided on the lower side of the third sleeve 33C to seal between the outer circumferential surface of the small-diameter portion 31 and the upper surface of the second rotary sealing ring 65.

A rolling bearing 4 is provided between the large-diameter portion 32 of the shaft body 30 and the first flange 21. A rolling bearing 5 is provided between the small-diameter portion 31 of the shaft body 30 and the fifth flange 25. Accordingly, the rotary shaft 3 is supported within the case body 2 so as to be rotatable around the center line X with respect to the case body 2.

### Mechanical Seal

A hydrostatic non-contact mechanical seal 6 is placed between the case body 2 and the rotary shaft 3. The mechanical seal 6 includes a first stationary sealing ring 61, a second stationary sealing ring 62, a third stationary sealing ring 63, a first rotary sealing ring 64, a second rotary sealing ring 65, a first elastic member 66, a second elastic member 67, and a third elastic member 68. The first stationary sealing ring 61, the second stationary sealing ring 62, and the third stationary sealing ring 63 are each formed in an annular shape and are provided on the inner circumferential side of the case body 2. The first rotary sealing ring 64 and the second rotary sealing ring 65 are each formed in an annular shape and are provided on the outer circumferential side of the rotary shaft 3.

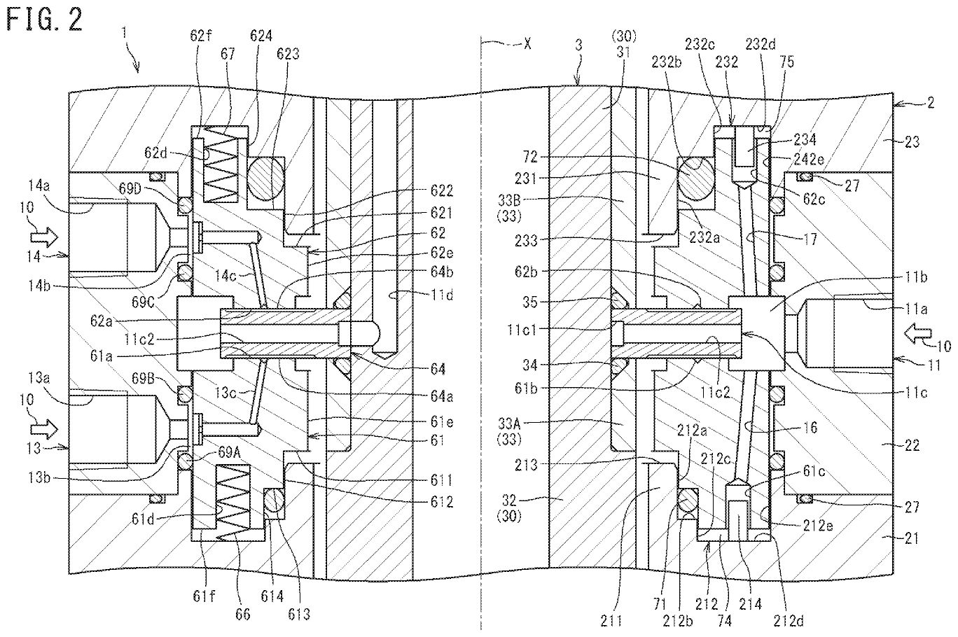

FIG. 2 is an enlarged cross-sectional view showing the lower side of the rotary joint 1. In FIG. 1 and FIG. 2, the first rotary sealing ring 64 is provided so as to be rotatable integrally with the rotary shaft 3. The first rotary sealing ring 64 of the present embodiment is fitted and fixed at a height position corresponding to the opening of the first inner flow passage 11d on the outer circumferential surface of the shaft body 30 of the rotary shaft 3. The lower end surface of the first rotary sealing ring 64 has a sealing surface 64a formed over the entire circumference thereof. The upper end surface of the first rotary sealing ring 64 has a sealing surface 64b formed over the entire circumference thereof.

The first stationary sealing ring 61 is placed below and adjacent to the first rotary sealing ring 64. A lower portion of the first stationary sealing ring 61 is attached to the protrusion 211 of the first flange 21 of the case body 2. Specifically, the lower portion of the first stationary sealing ring 61 is fitted into the mounting groove 212 of the protrusion 211 of the first flange 21. The mounting groove 212 is open upward at an upper end surface 213 of the first flange 21.

The mounting groove 212 has, in order from the radially inner side to the radially outer side, an inner circumferential surface 212a, a step surface 212b, a step circumferential surface 212c, a bottom surface 212d, and an outer circumferential surface 212e. The step surface 212b is formed in an annular shape. The step surface 212b is formed above the bottom surface 212d and is formed parallel to the bottom surface 212d. The step circumferential surface 212c is a cylindrical surface and has a diameter larger than that of the inner circumferential surface 212a and smaller than that of the outer circumferential surface 212e.

Between an inner circumferential surface 61e and a lower end surface 61f of the first stationary sealing ring 61, a first step surface 611, a first step circumferential surface 612, a second step surface 613, and a second step circumferential surface 614 are formed in this order. The first step surface 611 and the second step surface 613 are both formed in an annular shape. The first step circumferential surface 612 and the second step circumferential surface 614 are both cylindrical surfaces.

The first step surface 611 is located above and facing the end surface 213 of the first flange 21. The first step circumferential surface 612 is fitted onto the inner circumferential surface 212a of the mounting groove 212. The second step surface 613 is formed parallel to the first step surface 611 and is located above and facing the second step surface 212b of the mounting groove 212. The second step circumferential surface 614 is a cylindrical surface having a larger diameter than the first step circumferential surface 612. The second step circumferential surface 614 is located radially outward of and facing the inner circumferential surface 212a of the mounting groove 212 and is fitted onto the step circumferential surface 212c of the mounting groove 212. The lower end surface 61f of the first stationary sealing ring 61 is located above and facing a bottom surface 212d of the mounting groove 212.

On the lower end surface 61f of the first stationary sealing ring 61, a plurality of engagement holes 61c (only one is shown in FIG. 2) that are open downward are formed at intervals in the circumferential direction. In each engagement hole 61c, a pin 214 fixed to the bottom surface 212d of the mounting groove 212 is engaged. Accordingly, the first stationary sealing ring 61 is prevented from rotating by the case body 2, and its rotation with the first rotary sealing ring 64 is restricted.

The upper portion of the first stationary sealing ring 61 is placed between the first sleeve 33A on the rotary shaft 3 and the second flange 22 of the case body 2. The inner circumferential surface 61e of the first stationary sealing ring 61 is located with a gap with respect to the outer circumferential surface of the first sleeve 33A. The outer circumferential surface of the first stationary sealing ring 61 is located with a gap with respect to the inner circumferential surface of the second flange 22.

The upper end surface of the first stationary sealing ring 61 has a sealing surface 61a formed over the entire circumference thereof. The sealing surface 61a is located facing the lower sealing surface 64a of the first rotary sealing ring 64 in the axial direction. On the sealing surface 61a, an annular static pressure generation groove 61b is formed over the entire circumference thereof. The static pressure generation groove 61b of the present embodiment is formed in a V-shaped cross-sectional shape, for example.

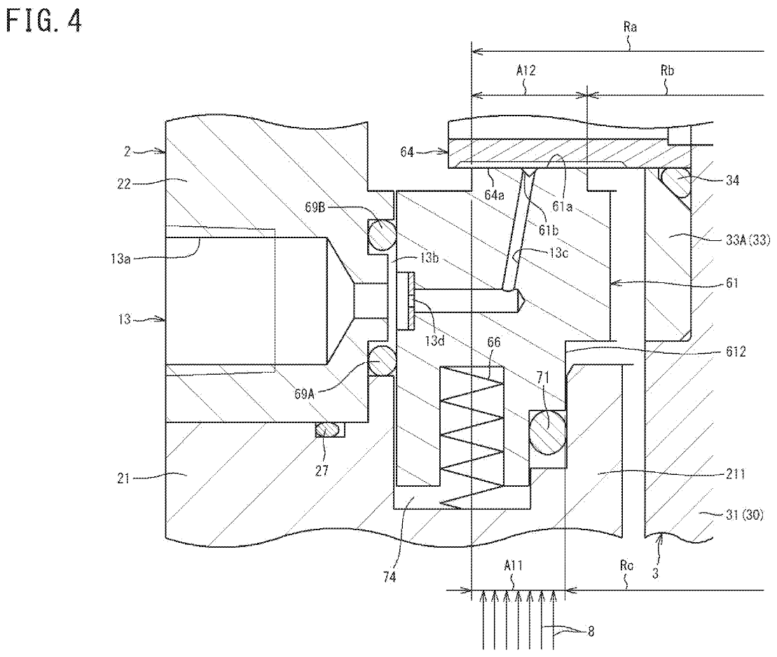

The space between the outer circumferential surface of the first stationary sealing ring 61 and the inner circumferential surface of the second flange 22 is sealed by lower and upper O-rings 69A and 69B that form a pair. The pair of O-rings 69A and 69B are placed with the opening on the inner circumferential side of the first gas supply passage 13a of the second flange 22 interposed therebetween. Accordingly, an annular first gas introduction chamber 13b into which the seal gas 10 is introduced from the first gas supply passage 13a is formed between the pair of O-rings 69A and 69B (see also FIG. 4).

Inside the first stationary sealing ring 61, a plurality of first gas communication passages 13c (only one is shown in FIG. 2) are provided at intervals in the circumferential direction. In the middle of each first gas communication passage 13c of the present embodiment, for example, an orifice-type throttle portion 13d is provided (see FIG. 4). One end of the first gas communication passage 13c is open at the outer circumferential surface of the first stationary sealing ring 61 and communicates with the first gas introduction chamber 13b. The other end of the first gas communication passage 13c is open at the static pressure generation groove 61b. Accordingly, the first gas communication passage 13c connects the first gas introduction chamber 13b and the static pressure generation groove 61b. The first gas supply passage 13a, the first gas introduction chamber 13b, and the first gas communication passage 13c constitute a first gas flow passage 13 through which the seal gas 10 is supplied to the static pressure generation groove 61b of the first stationary sealing ring 61.

A plurality of first elastic members 66 (only one is shown in FIG. 2) are provided in the circumferential direction between the first stationary sealing ring 61 and the bottom surface 212d of the mounting groove 212 of the first flange 21. Each first elastic member 66 is composed of, for example, a compression coil spring. The first elastic member 66 is inserted in a compressed state into a mounting hole 61d formed on the lower side of the first stationary sealing ring 61. One end portion (lower end portion) of the first elastic member 66 is in contact with the bottom surface 212d of the mounting groove 212. Accordingly, the first stationary sealing ring 61 is pressed upward toward the first rotary sealing ring 64 with respect to the case body 2 by the elastic restoring force of the first elastic member 66. The first elastic member 66 may be another elastic member other than a compression coil spring.

When the seal gas 10 is supplied from the first gas flow passage 13 to the static pressure generation groove 61b of the first stationary sealing ring 61, a static pressure is generated between the sealing surface 61a of the first stationary sealing ring 61 and the lower sealing surface 64a of the first rotary sealing ring 64 due to the seal gas 10. Due to this static pressure, the first stationary sealing ring 61 is held slightly downward from the first rotary sealing ring 64 against the elastic restoring force of the first elastic member 66. Accordingly, the space between both sealing surfaces 61a and 64a is sealed while being held in a non-contact state by the seal gas 10.

The second stationary sealing ring 62 is placed above and adjacent to the first rotary sealing ring 64. An upper portion of the second stationary sealing ring 62 is attached to the protrusion 231 of the third flange 23 of the case body 2. Specifically, the upper portion of the second stationary sealing ring 62 is fitted into the mounting groove 232 of the protrusion 231 of the third flange 23. The mounting groove 232 is open downward at a lower end surface 233 of the third flange 23.

The mounting groove 232 has, in order from the radially inner side to the radially outer side, an inner circumferential surface 232a, a step surface 232b, a step circumferential surface 232c, a bottom surface 232d, and an outer circumferential surface 232e. The step surface 232b is formed in an annular shape. The step surface 232b is formed below the bottom surface 232d and is formed parallel to the bottom surface 232d. The step circumferential surface 232c is a cylindrical surface and has a diameter larger than that of the inner circumferential surface 232a and smaller than that of the outer circumferential surface 232e.

Between an inner circumferential surface 62e and an upper end surface 62f of the second stationary sealing ring 62, a first step surface 621, a first step circumferential surface 622, a second step surface 623, and a second step circumferential surface 624 are formed in this order. The first step surface 621 and the second step surface 623 are both formed in an annular shape. The first step circumferential surface 622 and the second step circumferential surface 624 are both cylindrical surfaces.

The first step surface 621 is located below and facing the end surface 233 of the third flange 23. The first step circumferential surface 622 is fitted onto the inner circumferential surface 232a of the mounting groove 232. The second step surface 623 is formed parallel to the first step surface 621 and is located below and facing the step surface 232b of the mounting groove 232. The second step circumferential surface 624 is a cylindrical surface having a larger diameter than the first step circumferential surface 622. The second step circumferential surface 624 is located radially outward of and facing the inner circumferential surface 232a of the mounting groove 232 and is fitted onto the step circumferential surface 232c of the mounting groove 232. The upper end surface 62f of the second stationary sealing ring 62 is located below and facing the bottom surface 232d of the mounting groove 232.

On the upper end surface 62f of the second stationary sealing ring 62, a plurality of engagement holes 62c (only one is shown in FIG. 2) that are open upward are formed at intervals in the circumferential direction. In each engagement hole 62c, a pin 234 fixed to the bottom surface 232d of the mounting groove 232 is engaged. Accordingly, the second stationary sealing ring 62 is prevented from rotating by the case body 2, and its rotation with the first rotary sealing ring 64 is restricted.

A lower portion of the second stationary sealing ring 62 is placed between the second sleeve 33B on the rotary shaft 3 and the second flange 22 of the case body 2. The inner circumferential surface 62e of the second stationary sealing ring 62 is located with a gap in the radial direction with respect to the outer circumferential surface of the second sleeve 33B. The outer circumferential surface of the second stationary sealing ring 62 is located with a gap with respect to the inner circumferential surface of the second flange 22.

The lower end surface of the second stationary sealing ring 62 has a sealing surface 62a formed over the entire circumference thereof. The sealing surface 62a is located facing the upper sealing surface 64b of the first rotary sealing ring 64 in the axial direction. On the sealing surface 62a, an annular static pressure generation groove 62b is formed over the entire circumference thereof. The static pressure generation groove 62b of the present embodiment is formed in a V-shaped cross-sectional shape, for example.

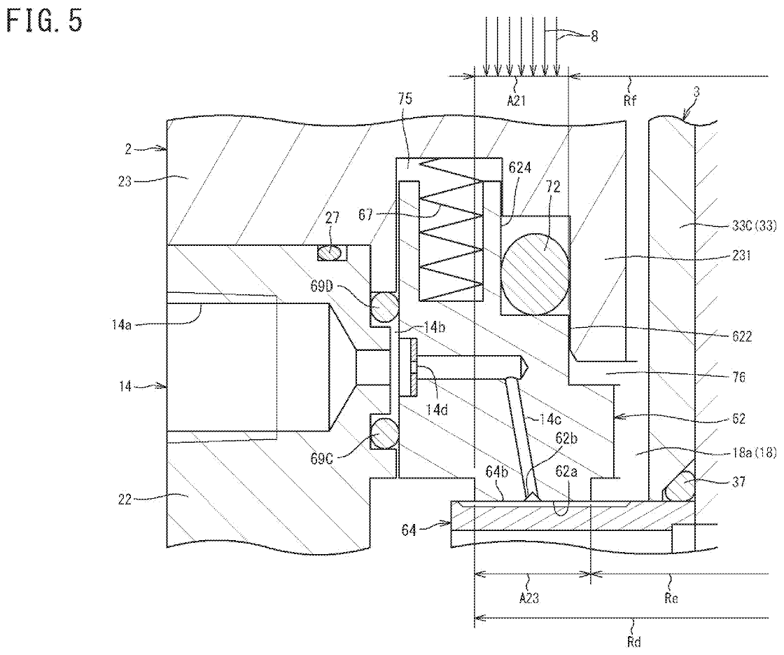

The space between the outer circumferential surface of the second stationary sealing ring 62 and the inner circumferential surface of the second flange 22 is sealed by lower and upper O-rings 69C and 69D that form a pair. The pair of O-rings 69C and 69D are placed with the opening on the inner circumferential side of the second gas supply passage 14a of the second flange 22 interposed therebetween. Accordingly, an annular second gas introduction chamber 14b into which the seal gas 10 is introduced from the second gas supply passage 14a is formed between the pair of O-rings 69C and 69D (see also FIG. 5).

Inside the second stationary sealing ring 62, a plurality of second gas communication passages 14c (only one is shown in FIG. 2) are provided at intervals in the circumferential direction. In the middle of each second gas communication passage 14c of the present embodiment, for example, an orifice-type throttle portion 14d is provided (see FIG. 5). One end of the second gas communication passage 14c is open at the outer circumferential surface of the second stationary sealing ring 62 and communicates with the second gas introduction chamber 14b. The other end of the second gas communication passage 14c is open at the static pressure generation groove 62b. Accordingly, the second gas communication passage 14c connects the second gas introduction chamber 14b and the static pressure generation groove 62b. The second gas supply passage 14a, the second gas introduction chamber 14b, and the second gas communication passage 14c constitute a second gas flow passage 14 through which the seal gas 10 is supplied to the static pressure generation groove 62b of the second stationary sealing ring 62.

A plurality of second elastic members 67 (only one is shown in FIG. 2) are provided in the circumferential direction between the second stationary sealing ring 62 and the bottom surface 232d of the mounting groove 232 of the third flange 23. Each second elastic member 67 is composed of, for example, a compression coil spring. The second elastic member 67 is inserted in a compressed state into a mounting hole 62d formed on the upper side of the second stationary sealing ring 62. One end portion (upper end portion) of the second elastic member 67 is in contact with the bottom surface 232d of the mounting groove 232. Accordingly, the second stationary sealing ring 62 is pressed downward toward the first rotary sealing ring 64 with respect to the case body 2 by the elastic restoring force of the second elastic member 67. The second elastic member 67 may be another elastic member other than a compression coil spring.

When the seal gas 10 is supplied from the second gas flow passage 14 to the static pressure generation groove 62b of the second stationary sealing ring 62, a static pressure is generated between the sealing surface 62a of the second stationary sealing ring 62 and the upper sealing surface 64b of the first rotary sealing ring 64 due to the seal gas 10. Due to this static pressure, the second stationary sealing ring 62 is held slightly away from the first rotary sealing ring 64 against the elastic restoring force of the second elastic member 67. Accordingly, the space between both sealing surfaces 62a and 64b is sealed while being maintained in a non-contact state by the seal gas 10.

In the first rotary sealing ring 64, a first communication flow passage 11c through which the first fluid 8 flows is formed. The first communication flow passage 11c is a flow passage for connecting the first outer flow passage 11a of the case body 2 and the first inner flow passage 11d of the rotary shaft 3. The first communication flow passage 11c includes an annular passage 11c1 that extends in the circumferential direction and a plurality of flow passage holes 11c2 that extend in the radial direction. The annular passage 11c1 is an annular groove formed over the entire circumference on the inner circumference of the first rotary sealing ring 64. The opening on the inner circumferential side of the annular passage 11c1 is located facing the opening of the first inner flow passage 11d on the outer circumferential surface of the rotary shaft 3 (shaft body 30).

The plurality of flow passage holes 11c2 are formed at intervals in the circumferential direction of the first rotary sealing ring 64. The opening on one side (the radially inner side of the first rotary sealing ring 64) of each flow passage hole 11c2 communicates with the annular passage 11c1. The opening on the other side (the radially outer side of the first rotary sealing ring 64) of each flow passage hole 11c2 is located facing the opening of the first outer flow passage 11a on the inner circumferential surface of the case body 2 (second flange 22).

Between the outer circumferential surface of the first rotary sealing ring 64 and the inner circumferential surface of the second flange 22, a first annular flow passage 11b is formed. The first annular flow passage 11b communicates with the first outer flow passage 11a of the case body 2 and also communicates with each flow passage hole 11c2 of the first communication flow passage 11c in the first rotary sealing ring 64. The first annular flow passage 11b is sealed by both sealing surfaces 61a and 64a of the first stationary sealing ring 61 and the first rotary sealing ring 64, both sealing surfaces 62a and 64b of the second stationary sealing ring 62 and the first rotary sealing ring 64, the O-ring 69B, and the O-ring 69C. The first outer flow passage 11a, the first annular flow passage 11b, the first communication flow passage 11c, and the first inner flow passage 11d constitute a first flow passage 11 through which the first fluid 8 flows in this order. The first fluid 8 may flow through the first flow passage 11 in the reverse direction.

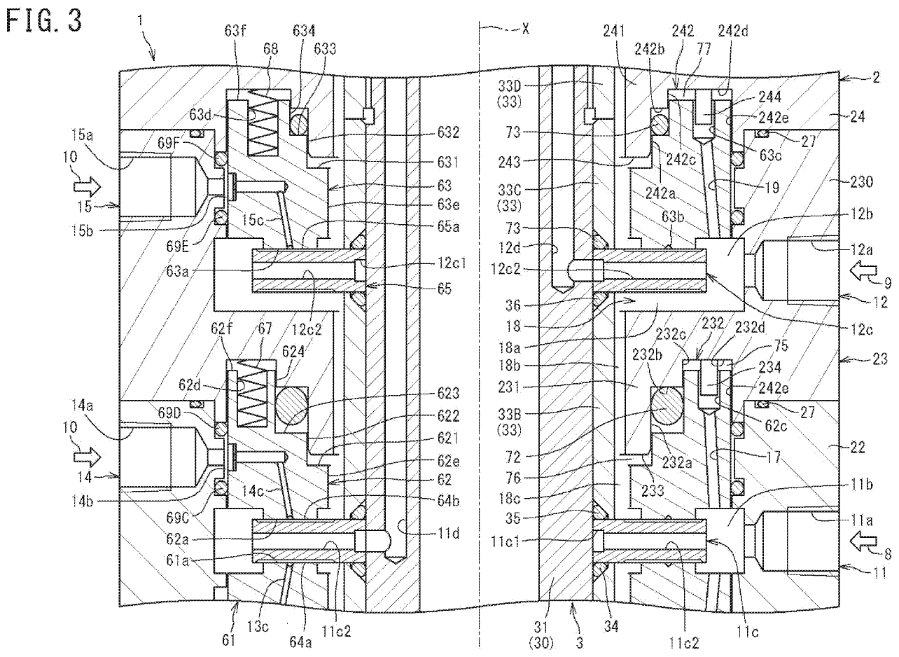

FIG. 3 is an enlarged cross-sectional view showing the upper side of the rotary joint 1. In FIG. 1 and FIG. 3, the second rotary sealing ring 65 is provided above the second stationary sealing ring 62 so as to be rotatable integrally with the rotary shaft 3. The second rotary sealing ring 65 of the present embodiment is fitted and fixed at a height position corresponding to the opening of the second inner flow passage 12d on the outer circumferential surface of the shaft body 30 of the rotary shaft 3, above the protrusion 231 of the third flange 23. The upper end surface of the second rotary sealing ring 65 has a sealing surface 65a formed over the entire circumference thereof.

The third stationary sealing ring 63 is placed above and adjacent to the second rotary sealing ring 65. An upper portion of the third stationary sealing ring 63 is attached to the protrusion 241 of the fourth flange 24 of the case body 2. Specifically, the upper portion of the third stationary sealing ring 63 is fitted into the mounting groove 242 in the protrusion 241 of the fourth flange 24. The mounting groove 242 is open downward at a lower end surface 243 of the fourth flange 24.

The mounting groove 242 has, in order from the radially inner side to the radially outer side, an inner circumferential surface 242a, a step surface 242b, a step circumferential surface 242c, a bottom surface 242d, and an outer circumferential surface 242e. The step surface 242b is formed in an annular shape. The step surface 242b is formed below the bottom surface 242d and is formed parallel to the bottom surface 242d. The step circumferential surface 242c is a cylindrical surface and has a diameter larger than that of the inner circumferential surface 242a and smaller than that of the outer circumferential surface 242e.

Between an inner circumferential surface 63e and an upper end surface 63f of the third stationary sealing ring 63, a first step surface 631, a first step circumferential surface 632, a second step surface 633, and a second step circumferential surface 634 are formed in this order. The first step surface 631 and the second step surface 633 are both formed in an annular shape. The first step circumferential surface 632 and the second step circumferential surface 634 are both cylindrical surfaces.

The first step surface 631 is located below and facing the end surface 243 of the fourth flange 24. The first step circumferential surface 632 is fitted onto the inner circumferential surface 242a of the mounting groove 242. The second step surface 633 is formed parallel to the first step surface 631 and is located below and facing the step surface 242b of the mounting groove 242. The second step circumferential surface 634 is a cylindrical surface having a larger diameter than the first step circumferential surface 632. The second step circumferential surface 634 is located radially outward of and facing the inner circumferential surface 242a of the mounting groove 242 and is fitted onto the step circumferential surface 242c of the mounting groove 242. The upper end surface 63f of the third stationary sealing ring 63 is located below and facing the bottom surface 242d of the mounting groove 242.

On the upper end surface 63f of the third stationary sealing ring 63, a plurality of engagement holes 63c (only one is shown in FIG. 3) that are open upward are formed at intervals in the circumferential direction. In each engagement hole 63c, a pin 244 fixed to the bottom surface 242d of the mounting groove 242 is engaged. Accordingly, the third stationary sealing ring 63 is prevented from rotating by the case body 2, and its rotation with the second rotary sealing ring 65 is restricted.

A lower portion of the third stationary sealing ring 63 is placed between the third sleeve 33C of the rotary shaft 3 and a flange body 230 of the third flange 23 of the case body 2. The inner circumferential surface 63e of the third stationary sealing ring 63 is located with a gap with respect to the outer circumferential surface of the third sleeve 33C. The outer circumferential surface of the third stationary sealing ring 63 is located with a gap with respect to the inner circumferential surface of the flange body 230.

The lower end surface of the third stationary sealing ring 63 has a sealing surface 63a formed over the entire circumference thereof. The sealing surface 63a is located facing the sealing surface 65a of the second rotary sealing ring 65 in the axial direction. On the sealing surface 63a, an annular static pressure generation groove 63b is formed over the entire circumference thereof. The static pressure generation groove 63b of the present embodiment is formed in a V-shaped cross-sectional shape, for example.

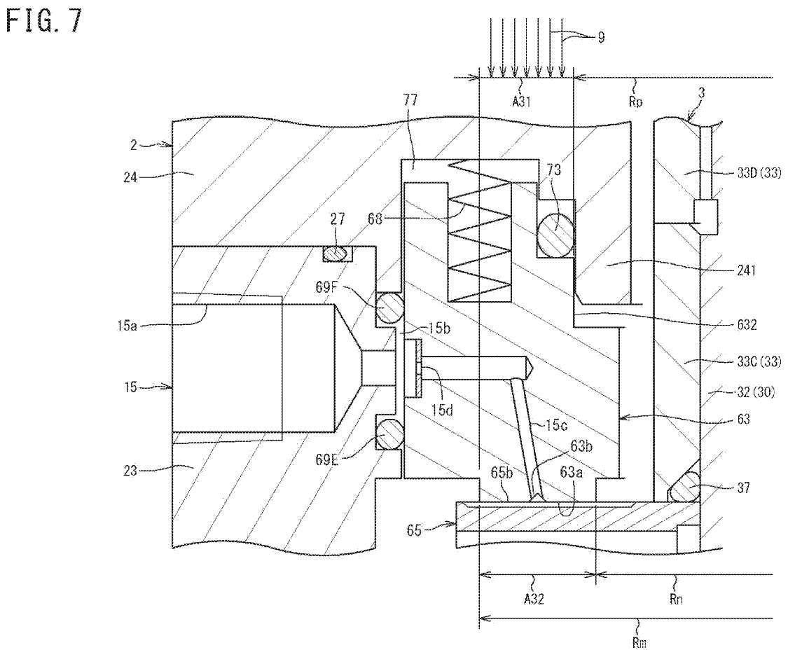

The space between the outer circumferential surface of the third stationary sealing ring 63 and the inner circumferential surface of the flange body 230 is sealed by lower and upper O-rings 69E and 69F that form a pair. The pair of O-rings 69E and 69F are placed with the opening on the inner circumferential side of the third gas supply passage 15a in the flange body 230 interposed therebetween. Accordingly, an annular third gas introduction chamber 15b into which the seal gas 10 is introduced from the third gas supply passage 15a is formed between the pair of O-rings 69E and 69F (see also FIG. 7).

Inside the third stationary sealing ring 63, a plurality of third gas communication passages 15c (only one is shown in FIG. 3) are provided at intervals in the circumferential direction. In the middle of each third gas communication passage 15c of the present embodiment, for example, an orifice-type throttle portion 15d is provided (see FIG. 7). One end of the third gas communication passage 15c is open at the outer circumferential surface of the third stationary sealing ring 63 and communicates with the third gas introduction chamber 15b. The other end of the third gas communication passage 15c is open at the static pressure generation groove 63b. Accordingly, the third gas communication passage 15c connects the third gas introduction chamber 15b and the static pressure generation groove 63b. The third gas supply passage 15a, the third gas introduction chamber 15b, and the third gas communication passage 15c constitute a third gas flow passage 15 through which the seal gas 10 is supplied to the static pressure generation groove 63b of the third stationary sealing ring 63.

A plurality of third elastic members 68 (only one is shown in FIG. 3) are provided in the circumferential direction between the third stationary sealing ring 63 and the bottom surface 242d of the mounting groove 242 of the fourth flange 24. Each third elastic member 68 is composed of, for example, a compression coil spring. The third elastic member 68 is inserted in a compressed state into a mounting hole 63d formed on the upper side of the third stationary sealing ring 63. One end portion (upper end portion) of the third elastic member 68 is in contact with the bottom surface 242d of the mounting groove 242. Accordingly, the third stationary sealing ring 63 is pressed downward toward the second rotary sealing ring 65 with respect to the case body 2 by the elastic restoring force of the third elastic member 68. The third elastic member 68 may be another elastic member other than a compression coil spring.

When the seal gas 10 is supplied from the third gas flow passage 15 to the static pressure generation groove 63b of the third stationary sealing ring 63, a static pressure is generated between the sealing surface 63a of the third stationary sealing ring 63 and the sealing surface 65a of the second rotary sealing ring 65 due to the seal gas 10. Due to this static pressure, the third stationary sealing ring 63 is held slightly apart from the second rotary sealing ring 65 against the elastic restoring force of the third elastic member 68. Accordingly, the space between both sealing surfaces 63a and 65a is sealed while being held in a non-contact state by the seal gas 10.

In the second rotary sealing ring 65, a second communication flow passage 12c through which the second fluid 9 flows is formed. The second communication flow passage 12c is a flow passage for connecting the second outer flow passage 12a of the case body 2 and the second inner flow passage 12d of the rotary shaft 3. The second communication flow passage 12c includes an annular passage 12c1 that extends in the circumferential direction and a plurality of flow passage holes 12c2 that extend in the radial direction. The annular passage 12c1 is an annular groove formed over the entire circumference on the inner circumference of the second rotary sealing ring 65. The opening on the inner circumferential side of the annular passage 12c1 is located facing the opening of the second inner flow passage 12d on the outer circumferential surface of the rotary shaft 3 (shaft body 30).

The plurality of flow passage holes 12c2 are formed at intervals in the circumferential direction of the second rotary sealing ring 65. The opening on one side (the radially inner side of the second rotary sealing ring 65) of each flow passage hole 12c2 communicates with the annular passage 12c1. The opening on the other side (the radially outer side of the second rotary sealing ring 65) of each flow passage hole 12c2 is located facing the opening of the second outer flow passage 12a on the inner circumferential surface of the case body 2 (flange body 230).

Between the outer circumferential surface of the second rotary sealing ring 65 and the inner circumferential surface of the flange body 230, a second annular flow passage 12b is formed. The second annular flow passage 12b communicates with the second outer flow passage 12a of the case body 2 and also communicates with each flow passage hole 12c2 of the second communication flow passage 12c in the second rotary sealing ring 65. The upper side of the second annular flow passage 12b is sealed by both sealing surfaces 63a and 65a of the third stationary sealing ring 63 and the second rotary sealing ring 65, and the O-ring 69F. The lower side of the second annular flow passage 12b communicates with a second back pressure flow passage 18, which will be described later. The second outer flow passage 12a, the second annular flow passage 12b, the second communication flow passage 12c, and the second inner flow passage 12d constitute a second flow passage 12 through which the second fluid 9 flows in this order. The second fluid 9 may flow through the second flow passage 12 in the reverse direction.

### Back Pressure Chamber and Back Pressure Flow Passage

In FIG. 2, the rotary joint 1 includes a back pressure chamber 74 formed below the first stationary sealing ring 61 and a back pressure flow passage 16 provided inside the first stationary sealing ring 61. The back pressure chamber 74 is sealed by the O-ring 69A placed on the outer circumferential side of the first stationary sealing ring 61 and a first sealing member 71 placed on the lower side and the inner circumferential side of the first stationary sealing ring 61. The back pressure chamber 74 is formed so as to extend from the gap between the O-ring 69A and the end surface 213 of the first flange 21, around the gap between the end surface 61f of the first stationary sealing ring 61 and the bottom surface 212d of the mounting groove 212, to the gap between the first sealing member 71 and a step surface 212b of the mounting groove 212.

The first sealing member 71 is, for example, an O-ring. The first sealing member 71 is provided between the second step circumferential surface 614 of the first stationary sealing ring 61 and the inner circumferential surface 212a of the mounting groove 212, and between the second step surface 613 of the first stationary sealing ring 61 and the step surface 212b of the mounting groove 212. The first sealing member 71 is in close contact with the second step circumferential surface 614 of the first stationary sealing ring 61 and the inner circumferential surface 212a of the mounting groove 212 and seals between these two surfaces 614 and 212a. The first sealing member 71 may be another sealing member other than an O-ring.

The back pressure flow passage 16 is a flow passage that connects the back pressure chamber 74 and the first flow passage 11. Although not shown, a plurality of back pressure flow passages 16 are provided at intervals in the circumferential direction of the first stationary sealing ring 61. Each back pressure flow passage 16 is formed independently of the first gas communication passage 13c so as to penetrate in the axial direction of the first stationary sealing ring 61. One end of the back pressure flow passage 16 is open on the radially outer side with respect to the sealing surface 61a at the upper end surface of the first stationary sealing ring 61. The other end of the back pressure flow passage 16 is open at the bottom surface of the engagement hole 61c.

A part of the first fluid 8 flowing through the first flow passage 11 passes from the first annular flow passage 11b through each back pressure flow passage 16 and flows into the back pressure chamber 74. Accordingly, the first stationary sealing ring 61 is subjected to the fluid pressure (back pressure) of the first fluid 8 within the back pressure chamber 74.

Each back pressure flow passage 16 of the present embodiment is provided in the first stationary sealing ring 61, but is not limited thereto. For example, the back pressure flow passage 16 may be provided from the second flange 22 to the first flange 21 of the case body 2, and may connect the first outer flow passage 11a of the first flow passage 11 and the back pressure chamber 74.

In FIG. 3, the rotary joint 1 includes a first back pressure chamber 75 and a second back pressure chamber 76 formed above the second stationary sealing ring 62, a first back pressure flow passage 17 provided inside the second stationary sealing ring 62, and the second back pressure flow passage 18 formed radially inward of the third flange 23.

The first back pressure chamber 75 is provided on the upper side and the radially outer side of the second stationary sealing ring 62. The first back pressure chamber 75 is sealed by the O-ring 69D placed on the outer circumferential side of the second stationary sealing ring 62 and a second sealing member (sealing member) 72 placed on the upper side and the inner circumferential side of the second stationary sealing ring 62. The first back pressure chamber 75 is formed so as to extend from the gap between the O-ring 69D and the end surface 233 of the third flange 23, around the gap between the end surface 62f of the second stationary sealing ring 62 and the bottom surface 232d of the mounting groove 232, to the gap between the second sealing member 72 and the step surface 232b of the mounting groove 232.

The second sealing member 72 is, for example, an O-ring. The second sealing member 72 is provided between the second step circumferential surface 624 of the second stationary sealing ring 62 and the inner circumferential surface 232a of the mounting groove 232, and between the second step surface 623 of the second stationary sealing ring 62 and the step surface 232b of the mounting groove 232. The second sealing member 72 is in close contact with the second step circumferential surface 624 of the second stationary sealing ring 62 and the inner circumferential surface 232a of the mounting groove 232 and seals between these two surfaces 624 and 232a. The second sealing member 72 may be another sealing member other than an O-ring.

The first back pressure flow passage 17 is a flow passage that connects the first back pressure chamber 75 and the first flow passage 11. Although not shown, a plurality of first back pressure flow passages 17 are provided at intervals in the circumferential direction of the second stationary sealing ring 62. Each first back pressure flow passage 17 is formed independently of the second gas communication passage 14c so as to penetrate in the axial direction of the second stationary sealing ring 62. One end of the first back pressure flow passage 17 is open on the radially outer side with respect to the sealing surface 62a at the lower end surface of the second stationary sealing ring 62. The other end of the first back pressure flow passage 17 is open at the bottom surface of the engagement hole 62c.

A part of the first fluid 8 flowing through the first flow passage 11 passes from the first annular flow passage 11b through each first back pressure flow passage 17 and flows into the first back pressure chamber 75. Accordingly, the second stationary sealing ring 62 is subjected to the fluid pressure (back pressure) of the first fluid 8 within the first back pressure chamber 75.

Each first back pressure flow passage 17 of the present embodiment is provided in the second stationary sealing ring 62, but is not limited thereto. For example, the first back pressure flow passage 17 may be provided from the second flange 22 to the third flange 23 of the case body 2, and may connect the first outer flow passage 11a of the first flow passage 11 and the first back pressure chamber 75.

The second back pressure chamber 76 is provided on the upper side and the radially inner side of the second stationary sealing ring 62. The second back pressure chamber 76 is partitioned from the first back pressure chamber 75 by the second sealing member 72 within the mounting groove 232. The second back pressure chamber 76 of the present embodiment is formed so as to extend from the gap between the second sealing member 72 and the second step surface 623 of the second stationary sealing ring 62, through the gap between the first step circumferential surface 622 of the second stationary sealing ring 62 and the inner circumferential surface 232a of the mounting groove 232, to the gap between the first step surface 621 of the second stationary sealing ring 62 and the end surface 233 of the third flange 23. The second back pressure chamber 76 may be partitioned from the first back pressure chamber 75 by a member other than the second sealing member 72.

The second back pressure flow passage 18 is a flow passage that connects the second back pressure chamber 76 and the second flow passage 12. The second back pressure flow passage 18 is formed using the protrusion 231 of the third flange 23, and has an axial gap 18a, an upper radial gap 18b, and a lower radial gap 18c.

The axial gap 18a is an annular gap formed between the upper end surface of the protrusion 231 of the third flange 23 and the lower end surface of the second rotary sealing ring 65. A radially outer end portion of the axial gap 18a communicates with the second annular flow passage 12b of the second flow passage 12.

The radial gap 18b is a cylindrical gap formed between the inner circumferential surface of the protrusion 231 of the third flange 23 and the outer circumferential surface of the second sleeve 33B of the rotary shaft 3. An upper end portion of the radial gap 18b communicates with a radially inner end portion of the axial gap 18a.

The radial gap 18c is a cylindrical gap formed between the inner circumferential side of the second stationary sealing ring 62 and the outer circumferential surface of the second sleeve 33B of the rotary shaft 3. An upper end portion of the radial gap 18c communicates with a lower end portion of the radial gap 18b and also communicates with a radially inner end portion of the second back pressure chamber 76.

A part of the second fluid 9 flowing through the second flow passage 12 passes from the second annular flow passage 12b through the axial gap 18a, the radial gap 18b, and the radial gap 18c of the second back pressure flow passage 18 in this order, and flows into the second back pressure chamber 76. Accordingly, the second stationary sealing ring 62 is subjected to the fluid pressure (back pressure) of the second fluid 9 within the second back pressure chamber 76.

The configuration of the second back pressure flow passage 18 is not limited to that of the present embodiment. For example, the second back pressure flow passage 18 may be formed by a dedicated component provided on the inner circumferential side of the third flange 23 of the case body 2.

The rotary joint 1 includes a back pressure chamber 77 formed above the third stationary sealing ring 63 and a back pressure flow passage 19 provided inside the third stationary sealing ring 63. The back pressure chamber 77 is sealed by the O-ring 69F placed on the outer circumferential side of the third stationary sealing ring 63 and a third sealing member 73 placed on the upper side and the inner circumferential side of the third stationary sealing ring 63. The back pressure chamber 77 is formed so as to extend from the gap between the O-ring 69F and the end surface 243 of the fourth flange 24, around the gap between the end surface 63f of the third stationary sealing ring 63 and the bottom surface 242d of the mounting groove 242, to the gap between the third sealing member 73 and the step surface 242b of the mounting groove 242.

The third sealing member 73 is, for example, an O-ring. The third sealing member 73 is provided between the second step circumferential surface 634 of the third stationary sealing ring 63 and the inner circumferential surface 242a of the mounting groove 242, and between the second step surface 633 of the third stationary sealing ring 63 and the step surface 242b of the mounting groove 242. The third sealing member 73 is in close contact with the second step circumferential surface 634 of the third stationary sealing ring 63 and the inner circumferential surface 242a of the mounting groove 242 and seals between these two surfaces 634 and 242a. The third sealing member 73 may be another sealing member other than an O-ring.

The back pressure flow passage 19 is a flow passage that connects the back pressure chamber 77 and the second flow passage 12. Although not shown, a plurality of back pressure flow passages 19 are provided at intervals in the circumferential direction of the third stationary sealing ring 63. Each back pressure flow passage 19 is formed independently of the third gas communication passage 15c so as to penetrate in the axial direction of the third stationary sealing ring 63. One end of the back pressure flow passage 19 is open on the radially outer side with respect to the sealing surface 63a at the upper end surface of the third stationary sealing ring 63. The other end of the back pressure flow passage 19 is open at the bottom surface of the engagement hole 63c.

A part of the second fluid 9 flowing through the second flow passage 12 passes from the second annular flow passage 12b through each back pressure flow passage 19 and flows into the back pressure chamber 77. Accordingly, the third stationary sealing ring 63 is subjected to the fluid pressure (back pressure) of the second fluid 9 within the back pressure chamber 77.

Each back pressure flow passage 19 of the present embodiment is provided in the third stationary sealing ring 63, but is not limited thereto. For example, the back pressure flow passage 19 may be provided from the third flange 23 to the fourth flange 24 of the case body 2, and may connect the second outer flow passage 12a of the second flow passage 12 and the back pressure chamber 77.

### Balance Ratio

FIG. 4 illustrates a balance ratio B1 of a sealing structure between the first stationary sealing ring 61 and the first rotary sealing ring 64. In FIG. 4, the outer shape of the first stationary sealing ring 61 is formed such that the balance ratio B1 is appropriate. Specifically, a pressure-receiving area A11 of the first stationary sealing ring 61 that is subjected to the fluid pressure of the first fluid 8 within the back pressure chamber 74 is set such that the balance ratio B1 is appropriate. The balance ratio B1 is the ratio (A11/A12) of the pressure-receiving area A11 to a sealing area A12 of the first stationary sealing ring 61.

The pressure-receiving area A11 is calculated by the following formula (1).

A11=π(Ra²−Rc²) (1)

Ra is the radius of the radially outer end of the sealing surface 61a of the first stationary sealing ring 61. Rc is the radius of the first step circumferential surface 612 of the first stationary sealing ring 61.

The sealing area A12 is the area of the sealing surface 61a of the first stationary sealing ring 61, and is calculated by the following formula (2).

A12=π(Ra²−Rb²) (2)

Ra is the radius of the radially outer end of the sealing surface 61a of the first stationary sealing ring 61, as described above. Rb is the radius of the radially inner end of the sealing surface 61a of the first stationary sealing ring 61.

Based on the above formulas (1) and (2), the balance ratio B1 is calculated by the following formula (3).

B1=(Ra²−Rc²)/(Ra²−Rb²) (3)

Therefore, the outer shape of the first stationary sealing ring 61 is formed such that the balance ratio B1 is appropriate, by adjusting the radius Ra of the radially outer end and the radius Rb of the radially inner end of the sealing surface 61a and the radius Rc of the first step circumferential surface 612.

In FIG. 3, when, of the first fluid 8 and the second fluid 9, only the first fluid 8 flows through the first flow passage 11, the second stationary sealing ring 62 is subjected to the fluid pressure of the first fluid 8 within the first back pressure chamber 75. On the other hand, when, of the first fluid 8 and the second fluid 9, only the second fluid 9 flows through the second flow passage 12, the second stationary sealing ring 62 is subjected to the fluid pressure of the second fluid 9 within the second back pressure chamber 76. For this reason, the outer shape of the second stationary sealing ring 62 is formed in consideration of the case of being subjected to the fluid pressure of the first fluid 8 within the first back pressure chamber 75 and the case of being subjected to the fluid pressure of the second fluid 9 within the second back pressure chamber 76.

Specifically, the outer shape of the second stationary sealing ring 62 is formed such that a first balance ratio B21 and a second balance ratio B22 of a sealing structure between the second stationary sealing ring 62 and the first rotary sealing ring 64 (hereinafter referred to as sealing structure 62, 64) are equivalent. The first balance ratio B21 is the balance ratio of the sealing structure 62, 64 when subjected to the fluid pressure of the first fluid 8 within the first back pressure chamber 75. The second balance ratio B22 is the balance ratio of the sealing structure 62, 64 when subjected to the fluid pressure of the second fluid 9 within the second back pressure chamber 76.

FIG. 5 illustrates a first balance ratio B21 of the sealing structure 62, 64. In FIG. 5, the first balance ratio B21 is the ratio (A21/A23) of a first pressure-receiving area A21 to a sealing area A23 of the second stationary sealing ring 62.

The first pressure-receiving area A21 is the pressure-receiving area of the second stationary sealing ring 62 that is subjected to the fluid pressure of the first fluid 8 within the first back pressure chamber 75. The first pressure-receiving area A21 is calculated by the following formula (4).

A21=π(Rd²−Rf²) (4)

Rd is the radius of the radially outer end of the sealing surface 62a of the second stationary sealing ring 62. Rf is the radius of the first step circumferential surface 622 of the second stationary sealing ring 62.

The sealing area A23 is the area of the sealing surface 62a of the second stationary sealing ring 62, and is calculated by the following formula (5).

A23=π(Rd²−Re²) (5)

Rd is the radius of the radially outer end at the sealing surface 62a of the second stationary sealing ring 62, as described above. Re is the radius of the radially inner end of the sealing surface 62a of the second stationary sealing ring 62.

Based on the above formulas (4) and (5), the first balance ratio B21 is calculated by the following formula (6).

B21=(Rd²−Rf²)/(Rd²−Re²) (6)

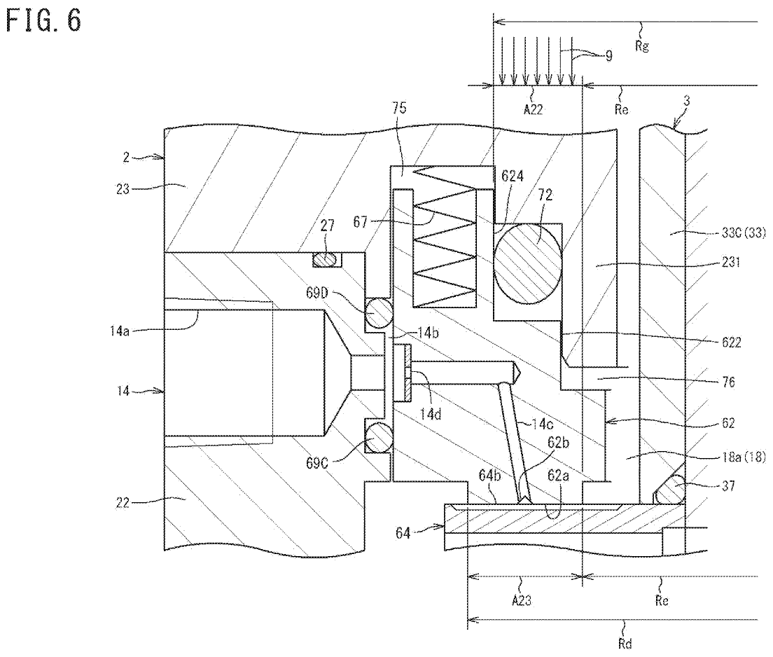

FIG. 6 illustrates a second balance ratio B22 of the sealing structure 62, 64. In FIG. 6, the second balance ratio B22 is the ratio (A22/A23) of a second pressure-receiving area A22 to the sealing area A23 of the second stationary sealing ring 62.

The second pressure-receiving area A22 is the pressure-receiving area of the second stationary sealing ring 62 that is subjected to the fluid pressure of the second fluid 9 within the second back pressure chamber 76. The second pressure-receiving area A22 is calculated by the following formula (7).

A22=π(Rg²−Re²) (7)

Rg is the radius of the second step circumferential surface 624 of the second stationary sealing ring 62. Re is the radius of the radially inner end of the sealing surface 62a of the second stationary sealing ring 62, as described above.

Based on the above formulas (5) and (7), the second balance ratio B22 is calculated by the following formula (8).

B22=(Rg²−Re²)/(Rd²−Re²) (8)

As described above, the outer shape of the second stationary sealing ring 62 is formed such that the first balance ratio B21 and the second balance ratio B22 of the sealing structure 62, 64 are equivalent. Therefore, based on the above formulas (6) and (8), the outer shape of the second stationary sealing ring 62 is formed so as to satisfy the relationship of the following formula (9).

(Rd²−Rf²)=(Rg²−Re²) (9)

In other words, the outer shape of the second stationary sealing ring 62 is formed such that the first balance ratio B21 and the second balance ratio B22 are equivalent, by adjusting the radius Rd of the radially outer end and the radius Re of the radially inner end of the sealing surface 62a, the radius Rf of the first step circumferential surface 622, and the radius Rg of the second step circumferential surface 624. Here, “equivalent” means that it only needs to be sufficiently similar to maintain the sealing performance of the sealing structure 62, 64, and it does not have to be completely identical.

FIG. 7 illustrates a balance ratio B3 of a sealing structure between the third stationary sealing ring 63 and the second rotary sealing ring 65. In FIG. 7, the outer shape of the third stationary sealing ring 63 is formed such that the balance ratio B3 is appropriate. Specifically, a pressure-receiving area A31 of the third stationary sealing ring 63 that is subjected to the fluid pressure of the second fluid 9 within the back pressure chamber 77 is set such that the balance ratio B3 is appropriate. The balance ratio B3 is the ratio (A31/A32) of the pressure-receiving area A31 to a sealing area A32 of the third stationary sealing ring 63.

The pressure-receiving area A31 is calculated by the following formula (10).

A31=π(Rm²−Rp²) (10)

Rm is the radius of the radially outer end of the sealing surface 63a of the third stationary sealing ring 63. Rp is the radius of the first step circumferential surface 632 of the third stationary sealing ring 63.

The sealing area A32 is the area of the sealing surface 63a of the third stationary sealing ring 63, and is calculated by the following formula (11).

A32=π(Rm²−Rn²) (11)

Rm is the radius of the radially outer end of the sealing surface 63a of the third stationary sealing ring 63, as described above. Rn is the radius of the radially inner end of the sealing surface 63a of the third stationary sealing ring 63.

Based on the above formulas (10) and (11), the balance ratio B3 is calculated by the following formula (12).

B3=(Rm²−Rp²)/(Rm²−Rn²) (12)

Therefore, the outer shape of the third stationary sealing ring 63 is formed such that the balance ratio B3 is appropriate, by adjusting the radius Rm of the radially outer end and the radius Rn of the radially inner end of the sealing surface 63a and the radius Rp of the first step circumferential surface 632.

### Advantageous Effects

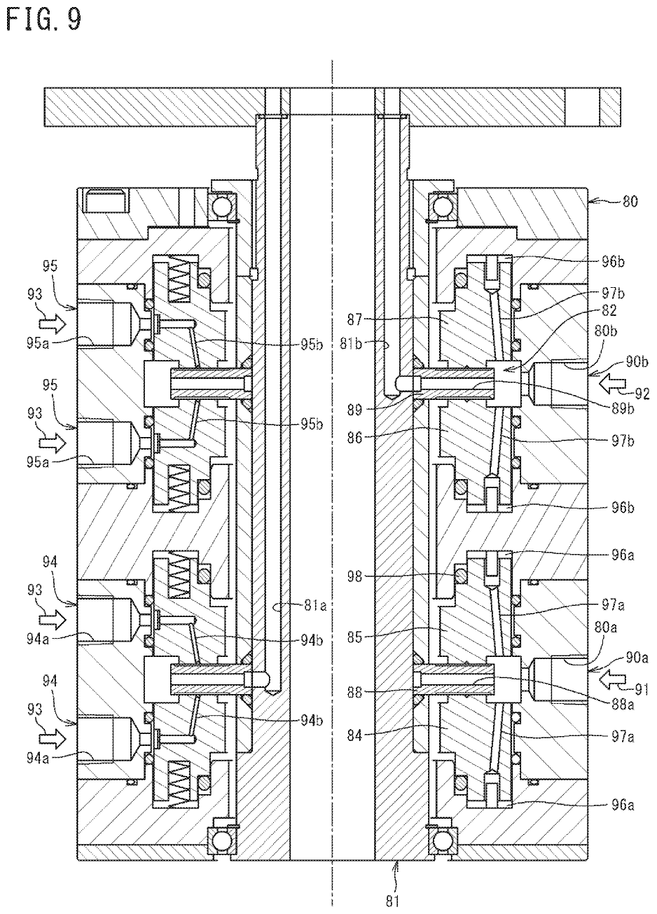

According to the rotary joint 1 of the present embodiment, when two communication flow passages (first communication flow passage 11c and second communication flow passage 12c) are arranged between the case body 2 and the rotary shaft 3, the mechanical seal 6 may include three stationary sealing rings (first stationary sealing ring 61, second stationary sealing ring 62, and third stationary sealing ring 63). In the conventional rotary joint (FIG. 9), the four stationary sealing rings 84 to 87 are required in order to provide the two communication flow passages 88a and 89b, so that the number of stationary sealing rings can be made smaller in the present embodiment. Therefore, according to the present embodiment, even when the number of communication flow passages increases, the overall length in the axial direction of the rotary joint 1 can be inhibited from becoming longer than in the conventional art.

The outer shape of the second stationary sealing ring 62 is formed such that the first balance ratio B21 when subjected to the fluid pressure of the first fluid 8 and the second balance ratio B22 when subjected to the fluid pressure of the second fluid 9 are equivalent. Therefore, the force that tends to close the space between the second stationary sealing ring 62 and the first rotary sealing ring 64 also becomes equivalent, and thus it is possible to inhibit the overall length in the axial direction of the rotary joint 1 from becoming longer than in the conventional art while maintaining the sealing performance of the mechanical seal 6.

Furthermore, as described above, the mechanical seal 6 includes three stationary sealing rings (first stationary sealing ring 61, second stationary sealing ring 62, and third stationary sealing ring 63), thereby providing three gas flow passages (first gas flow passage 13, second gas flow passage 14, and third gas flow passage 15) for the seal gas 10 to flow through. In the conventional rotary joint (FIG. 9), four gas flow passages (a pair of first gas flow passages 94 and a pair of second gas flow passages 95) are required in order to provide the two communication flow passages 88a and 89b, so that the number of gas flow passage rings can be made smaller in the present embodiment.

The second back pressure flow passage 18, which connects the second back pressure chamber 76 and the second flow passage 12, has the radial gap 18b between the protrusion 231, to which the second stationary sealing ring 62 is attached, and the rotary shaft 3, and the axial gap 18a between the protrusion 231 and the second rotary sealing ring 62. Therefore, by using the protrusion 231 to which the second stationary sealing ring 62 is attached, the second back pressure flow passage 18 can be easily formed.

Between the mounting groove 232 of the protrusion 231 and the second stationary sealing ring 62, the second sealing member 72 is provided to separate the first back pressure chamber 75 and the second back pressure chamber 76. Therefore, the first back pressure chamber 75 and the second back pressure chamber 76 can be easily formed by the second sealing member 72.

### Others

The rotary joint 1 of the above embodiment may be placed so as to be upside down in the axial direction or may be placed such that the axial direction is horizontal. Moreover, the rotary joint 1 can be applied to other devices such as CMP devices, sputtering devices, etching devices, in addition to the single-wafer cleaning device. Furthermore, the rotary joint 1 is not limited to use in the semiconductor field.

In the above embodiment, only the back pressure chamber 74, into which the first fluid 8 flows, is provided below the first stationary sealing ring 61. However, when a second flow passage 12 through which the second fluid 9 flows is separately provided below the first flange 21, a first back pressure chamber into which the first fluid 8 flows and a second back pressure chamber into which the second fluid 9 flows may be provided, similar to the second stationary sealing ring 62.

In the above embodiment, only the back pressure chamber 77, into which the second fluid 9 flows, is provided above the third stationary sealing ring 63. However, when a first flow passage 11 through which the first fluid 8 flows is separately provided above the fourth flange 24, a first back pressure chamber into which the first fluid 8 flows and a second back pressure chamber into which the second fluid 9 flows may be provided, similar to the second stationary sealing ring 62.

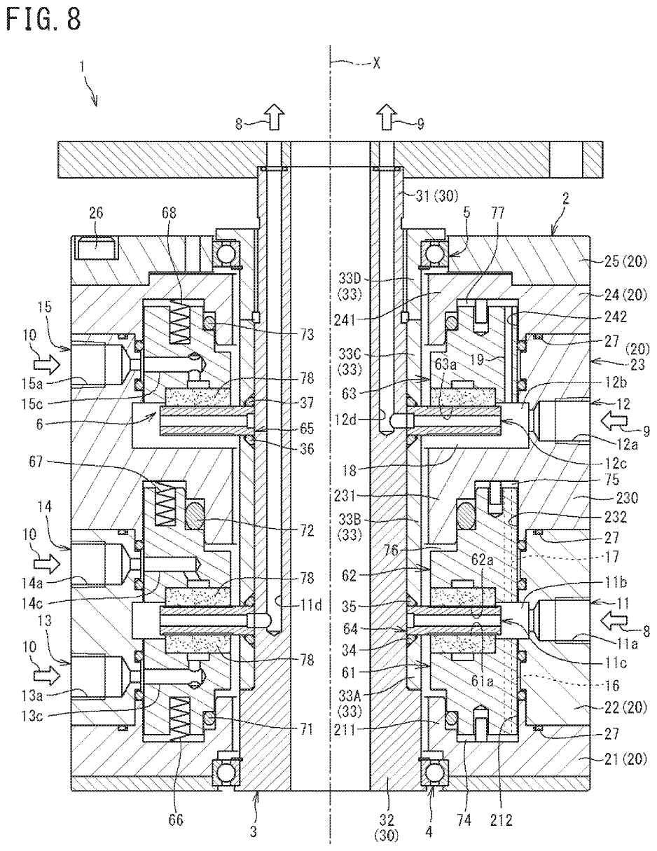

In the above embodiment, each stationary sealing ring 61, 62, or 63 of the mechanical seal 6 has the throttle portion 13d, 14d, or 15d in the middle of the gas communication passage 13c, 14c, or 15c, but is not limited thereto. For example, as shown in FIG. 8, each stationary sealing ring 61, 62, or 63 may include an annular porous body 78 having a sealing surface 61a, 62a, or 63a on the other end side of the gas communication passage 13c, 14c, or 15c (the rotary sealing ring 64 or 65 side) instead of the throttle portion 13d, 14d, or 15d. The porous body 78 has a large number of minute pores through which the seal gas 10 passes, and these pores can function as throttles.

The embodiment disclosed herein is merely illustrative in all aspects and should not be recognized as being restrictive. The scope of the present invention is defined by the scope of the claims rather than the meaning described above, and is intended to include meaning equivalent to the scope of the claims and all modifications within the scope.

### REFERENCE SIGNS LIST

1 rotary joint
2 case body
3 rotary shaft
6 mechanical seal
8 first fluid
9 second fluid
10 seal gas
11 first flow passage
11a first outer flow passage
11c first communication flow passage
11d first inner flow passage
12 second flow passage
12a second outer flow passage
12c second communication flow passage
12d second inner flow passage
17 first back pressure flow passage
18 second back pressure flow passage
18a axial gap
18b radial gap
61 first stationary sealing ring
62 second stationary sealing ring
63 third stationary sealing ring
64 first rotary sealing ring
65 second rotary sealing ring
72 second sealing member (sealing member)
75 first back pressure chamber
76 second back pressure chamber
231 protrusion
232 mounting groove

1. A rotary joint comprising:
a tubular case body having a first outer flow passage and a second outer flow passage that are open at an interval in an axial direction on an inner circumferential side;
a rotary shaft rotatably provided within the case body and having a first inner flow passage and a second inner flow passage that are open at an interval in the axial direction on an outer circumferential side; and
a hydrostatic non-contact mechanical seal placed between the case body and the rotary shaft and having a first communication flow passage for connecting the first outer flow passage and the first inner flow passage and a second communication flow passage for connecting the second outer flow passage and the second inner flow passage,
a first fluid flowing through a first flow passage including the first outer flow passage, the first communication flow passage, and the first inner flow passage, a second fluid flowing through a second flow passage including the second outer flow passage, the second communication flow passage, and the second inner flow passage, wherein
the mechanical seal includes
a first rotary sealing ring provided on the rotary shaft and having the first communication flow passage formed therein,
a first stationary sealing ring provided on one axial side of and adjacent to the first rotary sealing ring in the case body, a space between the first stationary sealing ring and the first rotary sealing ring being sealed in a non-contact manner by a seal gas,
a second stationary sealing ring provided on another axial side of and adjacent to the first rotary sealing ring in the case body, a space between the second stationary sealing ring and the first rotary sealing ring being sealed in a non-contact manner by the seal gas,
a second rotary sealing ring provided on the other axial side with respect to the second stationary sealing ring at the rotary shaft, and having the second communication flow passage formed therein, and
a third stationary sealing ring provided on the other axial side of and adjacent to the second rotary sealing ring in the case body, a space between the third stationary sealing ring and the second rotary sealing ring being sealed in a non-contact manner by the seal gas,
the rotary joint comprises
a first back pressure chamber, provided on the other axial side and a radially outer side of the second stationary sealing ring, for applying a fluid pressure of the first fluid to the second stationary sealing ring,
a second back pressure chamber, provided on the other axial side and a radially inner side of the second stationary sealing ring, for applying a fluid pressure of the second fluid to the second stationary sealing ring,
a first back pressure flow passage connecting the first back pressure chamber and the first flow passage, and
a second back pressure flow passage connecting the second back pressure chamber and the second flow passage, and
an outer shape of the second stationary sealing ring is formed such that a first balance ratio when subjected to the fluid pressure of the first fluid within the first back pressure chamber and a second balance ratio when subjected to the fluid pressure of the second fluid within the second back pressure chamber are equivalent.

2. The rotary joint according to claim 1, wherein
the case body has an annular protrusion that protrudes radially inward on the one axial side of the second rotary sealing ring and to which the second stationary sealing ring is attached,
the second back pressure flow passage has a radial gap between the protrusion and the rotary shaft, and an axial gap between the protrusion and the second rotary sealing ring,
the radial gap communicates with the second back pressure chamber, and
the axial gap communicates with the second flow passage.

3. The rotary joint according to claim 2, wherein
the protrusion has an annular mounting groove that is formed therein so as to be open on the one axial side and into which the second stationary sealing ring is fitted, and
the rotary joint further comprises a sealing member provided between the mounting groove and the second stationary sealing ring and partitioning the first back pressure chamber and the second back pressure chamber.
